(19) United States
(12) Patent Application Publication
(10) Pub. No.: US 2026/0135874 A1
(43) Pub. Date: May 14, 2026

(54) Automatic Detection and Handling of Security-Related Anomalies by Utilizing Machine Learning and a Large Language Model

(71) Applicant: VARONIS SYSTEMS, INC., New York, NY (US)

(72) Inventors: John Eugene Neystadt, Kfar Saba (IL); Lior Chen, Tel Mond (IL); Liron Raveh, Pardes Hanna - Karkur (IL); David Bass, Karmei Yosef (IL)

(21) Appl. No.: 18/945,613

(22) Filed: Nov. 13, 2024

(51) Int. Cl. H04L 9/40

(52) U.S. Cl. CPC H04L 63/1441

(57) ABSTRACT

Automatic detection and handling of security-related anomalies by utilizing machine learning and a large language model (LLM). A computerized method for detecting and handling security threats in an organizational network of an organization includes: (a) collecting event data that pertain to organizational users, organizational devices, and organizational resources of the organizational network; (b) constructing user profiles, device profiles, and resource profiles; (c) constructing Organizational Context information that pertains to organizational users, organizational devices, and organizational resources; (d) constructing a time-series of events, enriched with the Organizational Context information; (e) analyzing the time-series of events using a Machine Learning process that detects an anomalous event, and automatically generating an alert message pertaining to and describing the anomalous event.

### FIELD

Some embodiments are related to the field of computerized systems.

### BACKGROUND

A large corporation, organization, or other entity may have thousands of team-members who utilize computing devices for various purposes; for example, to send and receive electronic mail, to engage in video calls, to browse the Internet, to compose documents, to access data repositories, or the like.

The interaction of users with a variety of applications, as well as the sending and receiving of numerous messages and attached files, may create security risks to the organization and/or to the data and files that it maintains.

### SUMMARY

Some embodiments include systems, devices, and methods for automatic detection and handling of security-related anomalies in an organizational network, by utilizing Machine Learning (ML), Deep Learning (DL), a Large Language Model (LLM), and/or other Artificial Intelligence (AI) tools or models or units.

For example, a computerized method for detecting and handling security threats in an organizational network of an organization includes: (a) collecting event data that pertain to organizational users, organizational devices, and organizational resources of the organizational network; (b) constructing user profiles, device profiles, and resource profiles; (c) constructing Organizational Context information that pertains to organizational users, organizational devices, and organizational resources; (d) constructing a time-series of events, enriched with the Organizational Context information; (e) analyzing the time-series of events using a Machine Learning process that detects an anomalous event, and automatically generating an alert message pertaining to and describing the anomalous event.

Some embodiments may provide other and/or additional benefits and/or advantages.

### BRIEF DESCRIPTION OF THE DRAWINGS

FIG. 1 is a block-diagram illustration demonstrating components and operations of a system, in accordance with some demonstrative embodiments.

FIG. 2 is a schematic block-diagram illustration of a system, in accordance with some demonstrative embodiments

### DETAILED DESCRIPTION OF SOME DEMONSTRATIVE EMBODIMENTS

The Applicant has realized that some conventional computerized systems utilize a User and Entity Behavioral Analysis Engine, which is typically implemented by taking stream of logs or events and applying to them statistical methods (e.g., linear regression) in an attempt to detect anomalies. Such anomalies are then converted into security alerts, which can be remediated via user interaction or by automated response actions, for example, by disabling user accounts, blocking network traffic, quarantining files, removing permissions, or the like.

The Applicant has realized that conventional statistical methods for analyzing such event logs are limited in their nature: they are unable to take into account a broader context of an organization, namely, other information that indicate what else known about various affected or relevant entities, users, devices, data items, repositories, or the like.

The Applicant has realized that Organizational Context can be gathered, extracted and/or produced automatically and efficiently; for example, by crawling or searching or analyzing organizational directory for users and their respective roles, and/or by classifying data inside organizational data sources, and/or by constructing and updating user profiles and/or device profiles, and/or by analyzing audit events or event logs to identify which users/devices access what type of data, and/or to further identify or recognize patterns in such access or such activity (e.g., Graphic Designer Adam typically accesses marketing materials of the organization, but not financial records of the organization; Junior Developer does not typically access files on a Production server).

Accordingly, realized the Applicant, a profile can be constructed, corresponding to one or more entities/users/devices/resources, and indicating typical/past/recent/historic behavior that is related to that entity/user/device/resource, and/or reflecting access patterns or usage patterns that were extracted from past/recent/historic interactions, and/or reflecting other characteristics that can be derived from a user's role or position or title, and/or reflecting other characteristics derived from the device type, the resource type, or from other attributes of the relevant entities/users/devices/resources.

Some embodiments of the present invention provide a computerized system and an automated method that perform, or that enable, time-series analysis with LSTMs (Long Short-Term Memory) or TFT (Temporal Fusion Transformer) while combining it with Organizational Context of the events that are fed into the analysis of the time-series data, for example as static covariates for TFT or as augmented prompts for a Large Language Model (LLM). Such system and method can perform anomaly detection that is more precise, reducing false positive errors and/or reducing false negative errors. In some embodiments, optionally, a Covariates Engine 227 or a Static Covariates Engine may provide static organizational context (e.g., non-changing file sensitivity data, indicating that “all-salaries.xlsx” is always ultra sensitive, whereas “Public FAQ File.html” is always non-sensitive) to the anomaly detection models, as such covariates may optionally enhance the precision of ML/DL algorithms in some implementations by embedding important background information.

In a demonstrative embodiment, a computerized method may begin by performing gathering, production and/or generation of Organizational Context (OC). For example, an Organizational Resources Crawling Unit and Data Extractor may crawl and/or search and/or obtain data from organizational resources, directories, Active Directory (AD), Azure Active Directory (AAD), organizational chart, organizational contact lists, organizational files/folders/repositories, organizational data lake(s), organizational messages (e.g., email messages, Instant Messaging (IM) messages, messages exchanged via group messaging applications or project management applications), content of such messages, metadata of such messages (e.g., indicating that User Adam sent a message to User Bob on date D and at time T), metadata of files/folders/digital objects (e.g., creation date-and-time, modification date-and-time, access date-and-time), various data-items, calendar entries and scheduling entries (e.g., meeting invitations, list of meeting invitees and/or attendees, metadata of such scheduled meetings), documents, and/or other information stored in a variety of local and/or remote and/or cloud-based and/or on-premises repositories, databases, folders, drives, physical drives, virtual drives, data silos, Customer Relationship Management (CRM) systems, Supply Chain Management (SCM) systems, Enterprise Resource Planning (ERP) systems, file servers, file sharing applications, and/or other information sources or data repositories that typically form a “data lake” or a similar hybrid/combined/unified data repository.

The system scans such data, fully or entirely (e.g., initially when the system is deployed; and then periodically, such as once a week) and/or incrementally in response to one or more events of user activities and/or resource-related events in these systems (e.g., in response to an addition of a new user; in response to a deployment of a new repository). The system generates Organizational Context that may be represented by, for example, a Profile per each different organizational entities, such as, profiles for organizational users (e.g., based on a unique user identifier, username, user email account, or the like), profiles for organizational devices (e.g., based on a unique device identifier), profiles for organizational resources (e.g., files, folders, containers, repositories, physical drives, virtual drives accessed domains), and/or profiles for other stakeholders or partners (e.g., as optional examples, a non-employee director; a non-employee consultant; an external consultant, an external contractor, a business partner, a supplier or vendor of the organization, a customer or client of the organization).

Optionally, the system generates, for each such entity or profile, a list of features or attributes; for example, a user's title/role/position, a user's seniority level/ranking/tenure indicator, a user's department or organizational unit (e.g., marketing, finance, legal, development), a file's classification or type (e.g., spreadsheet, presentation, email message), and thereby constructs or provides history and classification of each entry that is initially crawled or that is subsequently incrementally added/updated.

The computerized method proceeds to perform Series Grouping. For example, an Anomaly Detection Engine is configured to continuously group together the received events, in series: it receives a stream of events (e.g., User Adam has created a new file titled “Budget.xlsx”; User Bob has deleted an existing file titled “Marketing-Plan.docx”), and it extracts from each event a list of entities (users, devices, organizational resources) to which this event pertains, such as a list of User ID numbers or strings, Device ID numbers or strings, Resource Identifier (or resource path) number or string, Partner/Stakeholder ID numbers or strings. The system groups the events into related time-series pivoting on the affected entity types per entity ID; such as, a time-series of events per user, a time-series of events per device, a time-series of events per resource, a time-series of events per partner/stakeholder, or the like.

In some embodiments, optionally, and particularly if the system is configured or deployed to do so, the system may generate a time-series of events per Group of Entities; for example, a single time-series of all the events that pertain to “any laptop computer of the Marketing Department”, or a single time-series of all the events that pertain to “any user who has permission to access the Production server”, or a single time-series of all the events that pertain to “any file that is stored in the Financials repository”.

It is noted that the same event can be part of multiple time-series; for example, User Adam has utilized his laptop computer to send File. xlsx to User Bob; this event can be placed by the system in the time-series of events that pertain to User Adam, and also in the time-series of events that pertain to User Bob, and also in the time-series of events that pertain to the laptop computer of User Adam, and also in the time-series of events that pertain to that file (or, to the folder/drive/repository in which that file is stored). Accordingly, the same even may appear in one or more user-related time-series of events, and/or one or more time-series of device-related time-series of events, and/or one or more time-series of resource-related time-series of events, and/or one or more time-series of stakeholder-related time-series of events.

The computerized method then proceeds to perform an Enrichment stage. For example, the Anomaly Detection Engine extracts related entities that were referenced by the events in a time-series, and for each such event/entity it extracts the relevant profiles from the Organizational Context database that was created. For example, for the time-series that pertains to User Adam, the Anomaly Detection Engine extracts a list of the resources (e.g., files, folders, containers) that User Adam has accessed, as part of this Enrichment stage; as well as the User Roles of User Adam (e.g., Senior Develop; Head of the Tiger Project). The Anomaly Detection Engine further performs collating of multiple references to the same entity; for example, if multiple events are performed by User Bob in the same time-series and they all refer to the same Folder, then the organizational context for that Folder is extracted only once.

The computerized method then proceeds to perform Anomaly Detection. First, partitioning is done on the time-series, using a suitable portioning process, such as overlapping partitions; such that each event appears in both the previous partition and the next partition. Then, the anomaly detection process is run on each time-series using TFTP or LSTM algorithms, passing or feeding or utilizing the Enrichment from the previous step as a Grounding constrain to a Large Language Model (LLM) that performs the analysis. In accordance with some embodiments, in order to reduce or limit the volume or size or amount of organization context (which can translate into, for example, reduced number of tokens used; reduced cost; fewer “hallucination” errors), only Enrichments that pertain to the entities that are referenced by events in the partition are passed or fed in the grounding of the LLM; for example, excluding or not-passing Enrichment data that pertains to entities that are not explicitly referenced by any of the events in the inspected time-series.

The computerized method then proceeds to the stages of Alerting and Remediation/Mitigation. For example, the identified anomalies are passed to an Alerting Engine, that assigns to each alert a severity score, and optionally suppresses or discards some alerts based on pre-configured or pre-defined alert discarding rules or alert discarding policies. If the alert is not immediately discarded as benign, then the system executes a Remediation/Mitigation flow, by invoking or performing one or more pre-defined mitigation/remediation/damage-prevention/risk-reducing actions, for example, disabling or freezing a user account, removing or freezing an access permission, blocking a firewall port, requiring stepped-up authentication from a user, requiring specific approval from an expert or a system administrator, quarantining a file or folder or repository or temporarily blocking all access to a particular file/folder/repository, or other pre-defined mitigation or remediation operations.

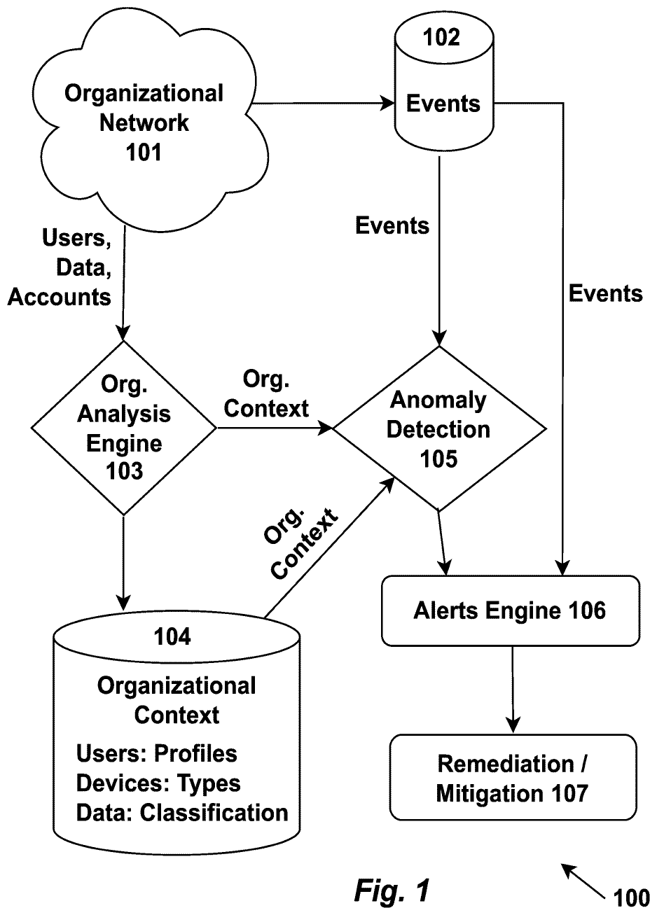

Reference is made to FIG. 1, which is a block-diagram illustration demonstrating components and operations of a system 100, in accordance with some demonstrative embodiments. System 100 may be implemented using hardware components and/or software components.

For example, an Organizational Network 101 is scanned, crawled, and/or monitored. Events in the organizational network are tracked, monitored, and logged into an Events Database 102; such as file access/write/read/create/modify/delete events, email messages send/receive events, user addition/removal events, device addition/removal events, access permission created/revoked/modified events, and/or other events related to files, folders, repositories, drives, users, user accounts, devices, organizational resources, or other objects or entities of the organization and/or related to the organization.

An Organization Analysis Engine 102 crawls or obtains or collects or extracts data from the Organizational Network 101; for example, user-related data, user account data, device-related data, organizational resources data, data about files/folders/repositories/drives/other objects, Active Directory (AD) information, Azure Active Directory (AAD) information, data from CRM/ERP systems, data from an organizational chart/tree/directory (e.g., an organization chart or structure tree, indicating managers, subordinates, same-level peers or same-tier peers, other-level peers or other-tier peers).

Optionally, a Peer Group Constructor/Analyzer 230 may identify user relationships and peer groups within the organization; for example, indicating that User Adam from Sales regularly corresponds on business matters with User Carl from Accounting, even though they are in different departments, since Adam has to request daily from Carl to prepare invoices for sale transactions that Adam made. Such peer group information, if indeed collected/generated by the organization, can optionally be part of the Organizational Context that is generated and subsequently used for anomaly detection. For example, the above-mentioned pattern of correspondence between Adam and Carl, can contribute to a “non-risky/non-anomalous” decision that the system would later reach if Carl sends a financial record to Adam; whereas, the lack of such pattern among Adam and David, and the fact that Adam and David do not belong to any common peer group and are not regarded as peers based on past interactions, can help the system subsequently determine that a new event in which David sends to Adam a sensitive financial record is anomalous or risky.

Organizational Context database 104 is constructed, and is then periodically/continuously/incrementally updated; for example, indicating or reflecting profiles of users, types of devices, classification(s) of documents and data-items.

Organizational Context is provided or fed as input to an Anomaly Detection Unit 105, which also receives/reviews Events from the Events Database 102; and generates output that is utilized by an Alerts Engine 106 to generate and send one or more alert messages or alert notifications, to one or more recipients that are relevant for each such alert (e.g., to a user or to a set of users to which a particular alert pertains; to a direct or indirect supervisor of such user or users; to a system administrator). A Remediation/Mitigation Unit 107 is triggered or invoked to handle each alert; for example, by discarding it or by marking it as benign in some situations, or by invoking or performing one or more pre-defined remediation/mitigation operations as discussed above.

Some embodiments provide a novel approach to security anomaly detection, by incorporating Organizational Context into the analysis of time-series data using advanced Machine Learning models. The system improves on conventional methods that rely solely on statistical analyses of logs and event streams, such as linear regression, to identify anomalies and potential security threats. Traditional techniques, realized the Applicant, are limited in their ability to consider broader organizational context, such as users'roles, devices, and typical patterns of data access. Some embodiments of the present invention address this gap by utilizing organizational information to significantly improve the accuracy of anomaly detection and reduce false positive errors and/or false negative errors.

The Applicant has realized that conventional anomaly detection systems use statistical approaches to analyze streams of log events, looking for deviations from a predefined norm. These deviations trigger alerts that typically lead to further user actions or automated responses, such as disabling user accounts, blocking network access, or quarantining files. However, realized the Applicant, such systems face several challenges: they lack the capability to analyze the organizational context of events, such as who is accessing specific files or how a user's behavior aligns with their role. As a result, they often produce incomplete or inaccurate alerts that fail to account for the broader context of an organization. For example, realized the Applicant, conventional systems may generate an alert that is actually a “false positive” error, if a user accesses a sensitive file, without understanding whether that access is unusual for the user based on their role within the organization; as conventional systems lack the ability to cross-reference events with organizational structures or historical behavioral patterns, limiting their effectiveness.

In order to mitigate and address these limitations, some embodiments of the present invention collect, generate, utilize and leverage Organizational Context, which includes automatically gathered data such as users'roles, devices, repositories, and data access patterns. This information is extracted through various sources like organizational directories, data lakes, audit logs/event logs, messaging systems, and other sources. The system constructs detailed profiles of each entity (e.g., user, device, or resource), reflecting historical behavior and access patterns/events pattern. For instance, it might profile a user based on their typical work activities, such as which files they access or what devices they use. The system also constructs similar profiles for devices and other organizational resources. This innovative profiling then enables the system to understand patterns such as “User Adam usually accesses marketing documents, but rarely interacts with financial records”, as an Organizational Context that can assist the system in deciding whether an access of User Adam to a new marketing document is an anomaly/a security risk (it is not), and whether an access of User Adam to a new financial record is an anomaly/a security risk (it is, or it is a candidate for such classification). Such insights can then be used to compare subsequent or fresh events against established behavioral patterns in view of already-extracted/already-collected Organization Context.

The system then performs Time-Series Grouping and applies Machine Learning (ML) or Deep Learning (DL) or other Artificial Intelligence (AI) methods to analyze such time-series information. The system is configured to organize event data into time-series, based on the entities involved. For example, events involving a particular user, device, or resource are grouped into corresponding time-series for further analysis. A single event, such as a user sending a file, can belong to multiple time-series—such as those involving the user, the device, and the file accessed. This flexible grouping ensures a comprehensive analysis of behavior and event sequences.

The system then applies ML/DL algorithms, such as Long Short-Term Memory (LSTM) networks or Temporal Fusion Transformers (TFT), to these time-series datasets. These models are particularly suited for analyzing time-dependent data and identifying patterns that may indicate anomalies. The invention further enhances these models by feeding them organizational context, either as static covariates or as inputs to a Large Language Models (LLM), allowing the system to achieve a more precise and context-aware anomaly detection.

For example, the system may utilize a user's profile to assess whether their access to a particular file is typical (authorized, non-risky) or anomalous (possibly un-authorized, possibly risky, possibly a security risk). If the behavior deviates from established patterns, the system flags the event as suspicious or anomalous and generates an alert notification. The use of LSTM or TFT models enables the system to analyze both the sequence of events and their broader context, leading to more accurate identification of anomalies while reducing “false positive” errors.

The system innovatively utilizes Enrichment and Anomaly Detection. For example, after grouping events into time-series and feeding the data into ML/DL model(s), the system enriches each event by referencing the Organizational Context database or portions extracted therefrom. This ensures that the system's analysis is grounded in relevant information about the users, devices, and resources involved. The enrichment process is configured to avoid overloading the system with unnecessary data, reducing potential costs, and/or preventing the generation of erroneous output due to excessive context.

In accordance with some embodiments, the anomaly detection process further includes partitioning the time-series data and analyzing each partition (of the time-series data) for unusual activity. Anomalies are flagged, and their severity is evaluated based on predefined thresholds or rules. The system can also be configured to suppress or discard false alarms that actually pertain to benign/non-risky events, ensuring that only high-priority alerts are acted upon.

For example, once anomalies are detected, they are passed to an Alerting Engine, which is optionally configured to determine or assign a severity score/risk score to each event. Based on these scores, the system can discard benign events or trigger one or more pre-defined remediation or mitigation actions. These actions can range from disabling or freezing user accounts, or blocking network access, to quarantining files or resources; with a goal to provide real-time responses to security threats while minimizing disruptions to normal operations.

In accordance with some embodiments, the remediation/mitigation stage can be entirely automated (e.g., an anomalous event automatically invokes a freezing or blocking of a particular user account, or automatically invokes a stepped-up authentication, or automatically invokes a quarantine of a file or folder or resource, or automatically invokes a freezing or a revocation of a user's access permission), or may be semi-automated and/or may require approval from a system administrator or a manager, depending on the estimated severity of the alert and in compliance with pre-defined organization policies and rules. This ensures a swift response to potential threats, while also offering flexibility in handling more complex scenarios.

The system and method of some embodiments thus provide a significant advancement in anomaly detection, by integrating Organizational Context with ML/DL algorithms such as LSTMs and TFTs. By constructing detailed profiles of users, devices, and resources, the system provides a more comprehensive understanding of organizational behavior, and improves the precision and accuracy of anomaly detection. The innovative use of time-series grouping, enriched data, and ML/DL models can reduce false positive errors and/or false negative errors, thereby enhancing an organization's ability to detect and respond to security threats. With its capacity for both automated and manual remediation, the system ensures that organizations can efficiently manage and mitigate risks while maintaining operational integrity.

Reference is made to

[symbol]

Some embodiments may utilize generation and integration of Organizational Context for the specific purpose of anomaly detection. The system creates and utilizes detailed Organizational Context, including user roles, device information, and data access patterns/event patterns. This allows for a more comprehensive analysis of security events by understanding the typical behavior of individuals and resources, providing context-based insights to reduce false alarms and improve precision.

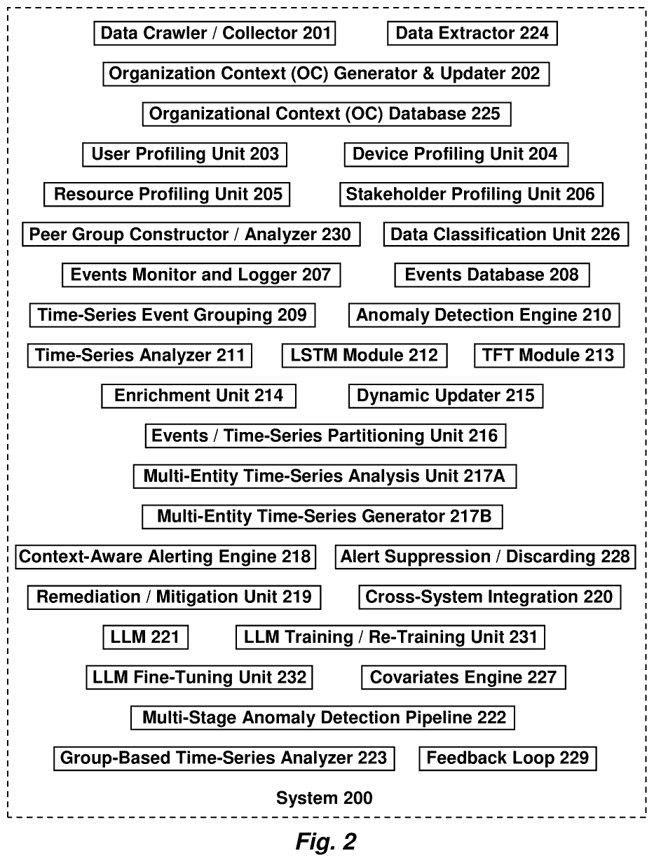

Reference is made to FIG. 2, which is a block-diagram illustration of a system 200, in accordance with some demonstrative embodiments. System 200 may be implemented using hardware components and/or software components.

For example, a Data Crawler/Collector 201 may crawl or review or analyze organization resources, such as files, folders, repositories, Active Directory (AD) information, Azure Active Directory (AAD) information, CRM information, ERP information, electronic messages (e.g., electronic mail; Instant Messaging (IM); group messaging applications), event logs and audit logs, organizational directory/tree structure, data about stakeholders (e.g., vendors, suppliers, clients, customers, partners, shareholders, directors, consultants, contractors), and/or other data. The organizational network encompasses all users, devices, and resources within an organization, and provides the system with the scope of entities to monitor, analyze, and protect. The Data Crawler/Collector 201 a similar organizational crawling unit can be configured to search through organizational directories, repositories, and databases and to gather information on users, devices, and files/folders/resources. The crawler constantly scans for updates and changes in organizational resources to provide the most up-to-date context for the anomaly detection system. Optionally, a Data Extractor Unit 224 may be configured to extracts specific data from organizational directories and resources, focusing on user roles, device types, and file classifications; and can transform raw organizational data into usable information for building profiles and analyzing behavior patterns.

In accordance with some embodiments, an Organizational Directory maintains structured information on users, devices, roles, and resources within the organization. This directory is continually updated by the crawling unit and serves as a reference point for generating user and device profiles. Similarly, an AD/AAD Interface may connect the system to AD/AAD or other structures or directories, enabling the retrieval of detailed user, device, and permission data. It ensures that all directory-related data is accurate and integrated into the anomaly detection process.

An Organization Context (OC) Generator & Updater 202 is configured to initially generate an initial version of the OC that is stored in an Organizational Context (OC) Database 225. The OC database 225 can store, for example, profiles of users, devices, and resources, including roles, behaviors, and interactions. This context database enables the system to cross-reference events against historical behaviors to determine whether activities are typical or anomalous. The Organization Context (OC) Generator & Updater 202 is also configured to update the organizational context, e.g., continuously, periodically, at particular time-intervals, upon triggering events, incrementally. In some embodiments, optionally, the Organization Context (OC) may be represented or stored as embeddings in a vector database or a vectorized database.

Some embodiments may utilize sub-units or modules that are responsible for generating particular Profiles, such as per device, per user, per resource, per stakeholder, or per other entity or object. For example, a User Profiling Unit 203 may automatically generate user profiles based on organizational data, reflecting users'roles, titles, assigned tasks, access patterns, and historical interactions/events that pertain to each such user. This profile-driven approach helps detect unusual activity specific to each user, improving the accuracy of security alerts by comparing events against individual behavioral norms. Similarly, a Device Profiling Unit 204 creates detailed profiles for each devices or machine, which can be a physical device or a virtual/virtualized device or unit that the organization utilizes. Each such profile includes a device's type, historical usage patterns, and interactions within the organization. This helps in detecting anomalies related to device behavior, such as unusual access to restricted resources or atypical usage times. Similarly, a Resource Profiling Unit 205 may create a profile per resource (e.g., per folder, per repository, per digital object); and optionally, a Stakeholder Profiling Unit 206 may create a profile per stakeholder that is not a defined user in the organizational network but still pertains to the organization and can still provide information useful as Organizational Context (e.g., vendors, suppliers, clients, customers, partners, shareholders, directors, consultants, contractors).

Accordingly, some embodiments may utilize a plurality of such Profiling Units or Profiling Engines as described; for example: (1) a User Profiling Engine that generates user profiles by analyzing user activity, job roles, and access patterns, and that continuously updates these profiles based on new data and interactions, providing a personalized baseline of behavior for anomaly detection; (2) a Device Profiling Engine, that builds and updates profiles for devices used within the organization; wherein device-specific data, such as access times and resource interactions, are logged and used to determine normal device behavior, ensuring accurate anomaly detection; (3) a Resource Profiling Engine, that generates profiles of organizational resources like files, folders, and databases by tracking access patterns and modifications; and can help identify anomalies in resource usage, such as unauthorized access to sensitive documents; (4) other relevant profiling units or engines, such as a Stakeholder Profiling engine or unit.

In some embodiments, a Data Classification Unit 226 is configured to classifies files, folders, documents, and other data objects based on attributes like file type, sensitivity, relatedness to a particular department or topic (e.g., marketing, legal, finance), and/or user permissions. This ensures that the system prioritizes security monitoring based on, or by taking into account the criticality of the data being accessed and/or the type of data being accessed. For example, a new, first-ever, read access by Junior Assistant Bob to the file “about-us. html”, that is already published on the organization's website, can thus be regarded as benign; whereas, a first-ever read access of that Junior Assistant to the file “All-Salaries.xlsx” may be regarded as risky.

An Events Monitor and Logger 207 is configured to monitor and log all events on the organizational network and/or that pertain to an organizational user/device/resource (and optionally stakeholder), thereby creating and updating an Events Database 208. For example, the Events Monitor and Logger 207 records events across the network, including (for example) file access, user login, and system modifications, thereby forming the foundation for detecting security anomalies by providing the event data to be processed. The Events Monitor and Logger 207 is always active, and continuously records events for future analysis. The Events Database 208 stores the logged events in an organized and searchable format; this database is important for later enabling the grouping of events into time-series and performing anomaly detection, and it can serve as the central repository for all user, device, and resource interactions.

Then, a Time-Series Event Grouping Unit 209 is configured to group or collect or organize or arrange event data into time-series based on users, devices, or resources (or stakeholders) involved. This enables a more structured analysis of events over time, helping the system to detect abnormal behavior patterns or sequences across multiple entities and providing a comprehensive timeline of interactions. The Time-Series Event Grouping Unit 209 can be configured to groups logged events into time-series based on the entities involved, such as users, devices, or resources, and in turn it enables the system to analyze behavior over time rather than as isolated events, enhancing detection accuracy.

In accordance with some embodiments, an Anomaly Detection Engine 210 operates using a Time-Series Analyzer 211, such as an LSTM Module 212 and/or a TFT Module 213, as the system utilizes ML/DL models, like Long Short-Term Memory (LSTM) and/or Temporal Fusion Transformers (TFT), to analyze the time-series data. These models are suitable for understanding temporal relationships, enabling precise detection of security anomalies by analyzing both event sequences and their broader organizational context.

The LSTM Module 212 may include an LSTM Model Processor, which is an ML/DL model designed to analyze time-series data, which focuses on detecting patterns over time and identifying deviations in expected behavior, ensuring that anomalies are caught early in the process. It is a particular type of Recurrent Neural Network (RNN), aimed at dealing with the vanishing gradient problem that is present in traditional RNNs or in a Hidden Markov Model (HMM). Its relative insensitivity to gap length is an advantage over other RNNs and over HMM, as the LSTM Module “remembers” (using a memory cell) older/previous data-items or intervals that RNN/HMM “forgets” over time or over iterations (as a traditional RNN has only a single hidden state that is passed through time); thus enabling the LSTM Module to learn long-term dependencies in the analyzed time-series.

The TFT Module 213 may include a TFT Model Processor, that processes time-series data by considering both short-term and long-term dependencies; it can capture complex patterns in behavior and identify nuanced anomalies across users, devices, and resources. For example, the TFT Module predicts and generate outputs based on inputs that include: (i) past target values (y) within a look-back window of length k; (ii) time-dependent exogenous input features that are composed of a-priori unknown inputs (z) and known inputs (x); (iii) static covariates(s) that provide contextual metadata about measured entities that does not depend on time. The TFT Module can output prediction intervals via quantiles.

It is noted that LSTM and TFT are only two demonstrative and non-limiting examples; and other models or modules or ML/DL/AI can be used, in addition or instead or in combination, in accordance with various embodiments.

An Enrichment Unit 214 enables or improves contextual analysis, as it enriches time-series data with relevant portions of the Organizational Context during the anomaly detection process. By incorporating relevant details, such as user roles or resource classifications, the system ensures that the ML/DL algorithms are grounded in real-world information, improving the accuracy of anomaly detection.

Optionally, a Dynamic Updater Unit 215 ensures that the system continuously crawls organizational directories, resources, and logs to collect updated information. This dynamic process ensures that the system's analysis is always based on the most current data, capturing changes like new users, devices, or data repositories in real time.

Furthermore, an Events/Time-Series Partitioning Unit 216 is utilized in order to enhance anomaly detection. It operates to partition time-series data into overlapping segments or partitions, in order to enable the system and its Anomaly Detection Engine 210 to separately detect anomalies within each such partition or segment. This method allows each event to be evaluated in multiple contexts, increasing the likelihood of identifying subtle or complex security threats by analyzing events from different perspectives. In some embodiments, the Events/Time-Series Partitioning Unit 216 or a similar Partitioning Engine/Unit can be configured to partition time-series data into overlapping segments, to allow each event to be analyzed within multiple contexts; and such partitioning process increases the likelihood of detecting subtle security anomalies across overlapping time frames.

Optionally, a Multi-Entity Time-Series Analysis Unit 217A may be utilized, since a single event can be part of multiple time-series, allowing the system to track user, device, and resource activities simultaneously. For example, a file transfer between two users can be analyzed in both users'time-series, as well as the device's and file's time-series, ensuring comprehensive monitoring of all involved entities. Optionally, such unit or a similar Multi-Entity Time-Series Generator 217B can create time-series not only for individual entities but also for groups of entities, such as all devices in a department. This broader perspective enables the detection of systemic anomalies across multiple entities.

In accordance with some embodiments, a Context-Aware Alerting Engine 218 is configured to estimate or determine or assign severity scores or risk scores to detected anomalies based on enriched contextual data. This ensures that only high-priority alerts are acted upon, while lower-risk events may be suppressed, improving overall response efficiency and reducing the burden on security teams. In some embodiments, the Context-Aware Alerting Engine 218 may operate in conjunction with an Alert Suppression/Discarding Unit 228, that automatically discards or suppresses alerts that are deemed benign based on pre-configured rules or policies. This feature helps reduce false positives and prevents unnecessary distractions for security teams.

Then, a Remediation/Mitigation Unit 219 selects and triggers/invokes/performs one or more pre-defined remediation/mitigation actions or processes, automatically or semi-automatically (e.g., subject to an approval from a system administrator or a manger), in response to specific alerts. These actions include, for example, temporarily or permanently disabling/blocking/freezing/limiting user accounts or user permissions, quarantining files or folders or other resources, blocking or quarantining network traffic, providing immediate security responses that can prevent further risk without requiring manual intervention, invoking a stepped-up authentication procedure, or other pre-defined operations.

Optionally, a Cross-System Integration Unit 220 operates to integrates data from various organizational systems, like Active Directory, Azure Active Directory (AAD), CRM systems, ERP systems, file management systems, or other resources or systems. The cross-system integration helps create a unified and more accurate Organizational Context, allowing for better identification of unusual patterns that span across multiple data sources.

In accordance with some embodiments, a Large Language Model (LLM) 221 can be used in a manner that enables efficient or token-efficient execution. For example, in order to optimize cost and reduce processing errors, the system selectively includes relevant enrichment data when feeding Organizational Context into the ML/DL model(s). This reduces token usage when interacting with large language models (LLMs), minimizing the chances of “hallucination” errors while maintaining efficient analysis. Optionally, an LLM interface/plug-in/add-on/extension can be used, to connect the system with an external or local or remote or co-located LLM, enabling enriched analysis of contextual data; and such interface allows the system to pass relevant context for deeper anomaly detection through machine learning. In some embodiments, the LLM may be or may include, for example, a Large Language Model or a large Vision and Language Model (LVM) or a Large Multi-modalities Model (LMM); such as OpenAI's ChatGPT, Microsoft Copilot, Google Gemini, Meta's Llama, Mistral, Anthropic's Claude, or other large models. In some embodiments, the LLM may be implemented as an array or matrix or series or set or group of LLM units/VLM units/LMM units, optionally utilizing a master LLM for distributing workload and/or for collating results and/or for aggregating insights. In some embodiments, such LLM may be local or co-located in the system or within the system, or may be co-located near the system, or may be external or remote or cloud-based, or may be a combination of such implementations.

In some embodiments, optionally, the LLM that is utilized can be a fine-tuned LLM that was specifically trained or re-trained or fine-tuned to specifically excel in the tasks of enriching time-series information of access events with relevant Organizational Context information. Optionally, an LLM Training/Re-Training Unit 231 and/or an LLM Fine-Tuning Unit 232 may be used to achieve such specialization. In some embodiments, the LLM fine-tuning may include adjustment of the model's parameters (weights and biases) to minimize the loss function specific to the task, typically by using gradient descent and back-propagation. In some embodiments, optionally, the fine-tuning of the LLM may provide several benefits or advantages, for example: (A) Specialization: while pre-trained language models have a broad understanding of language, they may not be optimized for specific jargon, styles, or nuanced expression used in particular domains (e.g., legal, medical, technical, and in this case security investigation/cyber-security investigation/anomaly detection/security-alerts generation). (B) Improved Performance: fine-tuning allows the model to adapt its parameters to the specifics of a dataset, which can lead to better performance metrics (such as accuracy, F1 score) on the desired task. (C) Task-Specific Knowledge: tasks like question-answering, summarization, or sentiment analysis may require the model to learn patterns that were not the focus of its initial pre-training. (D) Data Efficiency: Fine-tuning can sometimes achieve improved results with relatively small amounts of task-specific data, leveraging the knowledge already encoded in the model during pre-training. (E) Addressing or mitigating Data Bias: Pre-trained models can inherit biases from their training data; fine-tuning on a more balanced or curated dataset can help mitigate these biases.

In some embodiments, the optional fine-tuning process of the LLM may include multiple steps; for example: (a) Initialization: the model starts with weights that have been learned during its pre-training phase; (b) Further Training: the model is fine-tuned using a task-specific dataset, that is much smaller than the one used for pre-training, and contains examples of the particular task that the model needs to perform, by providing pairs of example input and expected (correct, perfect, optimal) example output; (c) Parameter Adjustment: During fine-tuning, the model's parameters (weights and biases) are updated to minimize the loss function specific to the task, typically by using gradient descent and back-propagation; (d) Learning Rate: a lower learning rate is used in the fine-tuning, compared to the initial pre-training phase, to make smaller adjustments to the weights and avoid overwriting the pre-existing knowledge encoded in the model; thus ensuring that the model does not “forget” the initial information it was trained on but will learn the new capabilities; (e) Regularization: techniques like early stopping or dropout may be used to prevent over-fitting to the fine-tuning dataset, ensuring that the model retains its generalizability; (f) Freezing Layers: Sometimes, only a portion of the model's layers are fine-tuned while others are “frozen”; the last few layers are fine-tuned because they are more task-specific, while earlier layers capture general language features; (g) The fine-tuning is a balancing act between retaining the vast knowledge that the model had already gained during pre-training and adapting it sufficiently to excel at a specific task, with the end goal to have a model that can understand and generate text in a way that is tailored to the requirements of the particular application.

Optionally, some embodiments may be configured to perform fine-tuning of the LLM to make it specifically suited for the task of enriching time-series of events with Organizational Context. For example, a set of documents (e.g., dozens, or even hundreds of documents) may be prepared for the fine-tuning process, to be embedded in a Vector Database. Each of those exemplary dataset items contains: (a) a given time-series of events data, and (b) the correct/expected/accurate/optimal enrichment or output that the LLM should generate. The dataset of “correct examples” can then be used for fine-tuning the LLM.

In some embodiments, a Multi-Stage Anomaly Detection Pipeline 222 is used, comprising two or more of the units described above and/or other units, in a pipeline or a staggered manner or a cascaded manner. The system implements a multi-stage anomaly detection process that begins with context gathering and profiling, followed by event grouping, enrichment, and partitioning. This structured pipeline ensures that every anomaly is thoroughly vetted, enriched, and scored before an alert or remediation action is triggered.

Optionally, some embodiments may utilize a Group-Based Time-Series Analyzer 223, which can create time-series not only for individual users, devices, or resources, but also for groups (e.g., all laptops in the Marketing Department; all users in the Legal Department). This optional feature may allow the detection of additional patterns that may exist within larger entity groups, helping to identify systemic issues or coordinated anomalies across departments or teams, or enabling the system to decide that a particular risk or anomaly is actually benign. For example, if 17 out of 18 laptops of the Marketing Department have been used to access the document “Annual-Budget.docx” in the past 30 days, then a new, first-ever, access from Laptop 18 of the Marketing Department towards that same document may be regarded as authorized/benign/non-anomalous. Similarly, if 34 out of 35 users that are members in the Legal Department have never accessed the folder “Project-Source-Code” in the past 12 months, then a new, first-ever, access by User 35 in the Legal Department towards that same folder may be regarded as anomalous/risky/un-authorized. Such insights may be derived, innovatively, by optionally constructing a time-series of events that pertain to a particular, defined, Group of users or Group of devices or Group of resources; thereby uncovering insights that cannot always be uncovered by analyzing a single time-series that pertains to a single user/device/resource.

Some embodiments of the present invention may provide one or more, or some, or most, or all, of the following surprising or non-obvious or counter-intuitive features. (1) User-Specific Anomaly Detection, such that instead of relying on general behavior patterns and statistical analysis that is user-agnostic, the system can tailor anomaly detection to each user's unique role and behavior, allowing personalized security assessments that catch subtle irregularities others might miss, reducing unnecessary alerts for typical user behavior. (2) Overlapping Time-Series Analysis, as events are placed in multiple time-series (e.g., user based, device based, resource based), allowing for a more accurate and holistic analysis of an event's context, in a multi-perspective approach that enhances accuracy; note that this is counter-intuitive since traditional methods typically isolate events into singular streams. (3) Token-Efficient LLM Interaction, as the system selectively includes only necessary and selected portions of the Organization Context when feeding data into LLM, thereby reducing token use, which improves cost efficiency and reduces hallucination risks; and this approach may be regarded as surprising as often more data is generally expected to improve AI analysis. (4) Anomaly Detection that is Grounded in Organizational Structure, unlike conventional systems that focus solely on event data; in contrast, the system of the present invention enriches time-series analysis with an understanding of organizational hierarchy, roles, and responsibilities, which is an unexpected feature that can prove advantageous for differentiating normal from anomalous behavior. (5) Optionally, Group-Based Time-Series creation and utilization may be employed, with an innovative ability to create time-series for groups, such as all devices in a department; which in turn may allow for a broader detection of systemic anomalies, in contrast with conventional focus on individual users or individual devices in conventional detection systems. (6) Context-Driven Alert Filtering, as the system can be configured to discard benign alerts based on enriched contextual understanding; which is a surprising aspect for systems that are typically designed to flag as many anomalies as possible; this feature allows to reduce false positive errors, and allows to prioritize critical alerts. (7) Dynamic Crawling for Continuous Context Updates, as the organizational context is continuously updated incrementally through dynamic crawling, which contrasts with static detection models; thereby ensuring that the system is operating with the latest organizational insights. (8) Optionally, Cross-Domain Event Correlation can be used, such that events spanning different domains (e.g., CRM systems and file servers) are correlated or aggregated or grouped for anomaly detection, enabling insights that are not discoverable (at all, or efficiently) in isolated domains; thereby making security monitoring more robust. (9) Optionally, automatic pre-defined Remediation/Mitigation processes, without human oversight or semi-automatically (subject to human approval), as the system can be configured to automatically trigger remediation actions; this might appear counter-intuitive in traditional security models, yet it can improve response time to real-time threats. (10) Role-Based Access Prediction/Analysis, as based on analyzing of past behavior, the system predicts role-specific access patterns, identifying anomalies when users step outside these patterns, enabling a proactive approach to security management.

In some embodiments, optionally, the generation and handling of Time-Series can be implemented using several sub-units or sub-modules, such as: (1) Time-Series Constructor Unit, that generates structured time-series from event logs, grouping data based on user, device, or resource interactions; his component ensures that events are organized in chronological order, allowing the system to analyze behavior patterns over time and track anomalies more effectively. (2) Time-Series Analyzer Unit, that analyzes time-series data to identify patterns, trends, or irregularities; it applies the ML/DL algorithms to detect unusual sequences of events, ensuring that even subtle deviations from normal behavior are flagged for further inspection. (3) Time-Series Correlation Engine, that can cross-reference different two-or-more time-series in order to identify correlated events across users, devices, or resources; and can help in detecting coordinated activities or multi-entity anomalies that may not be obvious when analyzing individual time-series in isolation. (4) Time-Series Segmentation Unit, that splits long time-series into smaller, more manageable segments for focused analysis; and can ensure that the system can detect localized anomalies within specific time windows, enhancing precision by focusing on short-term behavioral deviations within broader patterns. (5) Time-Series Aggregation Unit, that can aggregate related time-series into broader sets, such as grouping all time-series for users in a particular department; and can enable the system to detect group-level anomalies that could indicate systemic security issues or coordinated attacks. (6) Historical Time-Series Comparator, that can compare current time-series with historical data to detect deviations from long-term behavioral norms; and can ensure that the system identifies significant shifts in user or device behavior that might signal security threats or policy violations. (7) Time-Series Pattern Recognition Engine, that can identify recurring patterns within time-series data, helping to differentiate between normal cyclical behavior and anomalies; and can assist the system in for understanding user habits, such as working hours or working days, or the relation between users and tasks/files/devices/resources, in order to minimize false positive errors while also enhancing anomaly detection. (8) Time-Series Forecasting Unit, which can optionally utilize one or more predictive models to forecast future behavior based on existing time-series, and can optionally enable proactive anomaly detection by highlighting potential future deviations before they occur, helping organizations prepare for security threats before they manifest. (9) Multi-Dimensional Time-Series Processing Unit, which can optionally create and processes multi-dimensional time-series, where each event includes multiple parameters (e.g., user, device, time, resource; or other combination of two or more parameters); and such processing unit can detect anomalies by analyzing the interactions between multiple variables, offering a deeper and more nuanced analysis of organizational behavior.

In some embodiments, a Feedback Loop Unit 229 can be used to provide and to implement a feedback loop mechanism that can improve the accuracy of the system's performance over time; as incorporating such feedback loop mechanism into the system can enhance its adaptability and precision over time. The mechanism can involve real-time user engagement and can ensure that the system learns from its past performance, improving its future anomaly detection capabilities, alert generation, and remediation strategies. By allowing users to evaluate the accuracy and relevance of system-generated alerts, as well as the effectiveness of mitigation actions, the self-learning system can become more intelligent, dynamic, and tailored to the specific operational environment.

As a demonstrative workflow of such Feedback Loop mechanism, it may begin after an alert has been generated by the system. Once an anomaly is detected and the alerting engine triggers a notification, the user is prompted to provide feedback. The steps involved in this feedback process can be in accordance with the following example. (1) Alert Generation and Mitigation Proposal, performed when an anomaly is detected; the system's alerting engine assigns a severity score/risk score, and proposes appropriate remediation/mitigation steps based on the anomaly's context. The relevant user or decision-maker can be notified through a dashboard, an email message, an instant message, or other communication channels, and a detailed description of the anomaly can be provided, including information about the users, devices, or resources involved, the severity score/risk score, and the system's proposed mitigation actions. (2) User Evaluation and Feedback Submission, performed after receiving the alert; the user can interact with the system to evaluate the validity of the alert and the proposed remediation actions. For example, this feedback may include: (2a) Accuracy of the Alert - was the alert correct, or was it a false positive; the user can confirm if the behavior detected was indeed suspicious or if it was a normal, permissible activity that the system incorrectly flagged; (2b) Risk Assessment—the user can adjust the severity score/the risk score, categorizing the detected anomaly as high risk, moderate risk, or low risk based on their judgment and expertise; (2c) Mitigation Appropriateness—reflecting feedback on whether the proposed remediation actions are or were (or are expected to be) suitable or overbearing; for instance, if the system recommended disabling a user account for one week, but the user believes that a more appropriate action would be or would have been to quarantine a file for 24 hours, then the user can provide such feedback; (2d) Additional Comments, as users can provide any additional insights or contextual details that were not factored into the system's analysis, such as known system behavior or ongoing maintenance that could explain the detected anomaly, or a user-provided insights that Junior Developer Bob was indeed tasked today with a rare task of accessing a Production server for a particular and limited goal. (3) Feedback Storage, as once the user submits their feedback, it is stored in a dedicated Feedback Database, or (optionally) in a Vector Database; and such storage allows the system to record the specifics of each feedback instance, including: (3a) The event details and the time-series data involved in the alert; (3b) The original system-generated severity score/risk score, and the user-modified score; (3c) The system's proposed mitigation actions, and the user's feedback on their appropriateness; (3d) Any additional comments provided by the user as feedback. (4) Aggregation and Utilization of Feedback Data, as the system continually aggregates the feedback data to improve its decision-making process in future iterations. The feedback is not just stored in isolation; rather, it can be analyzed and used as additional context to refine anomaly detection and alerting mechanisms. (5) Updating User and Entity Profiles, as the feedback that is provided on specific alerts can be fed back into the User Profiling Engine, Device Profiling Engine, and Resource Profiling Engine, or other profiling engines/profiling units. For example, if a user consistently marks certain actions as low-risk or non-anomalous, the system can learn that such behavior is normal for that user and adjust its model to reduce “false positive” errors in the future. (6) Adjusting Time-Series Analysis, as the system can incorporate feedback into its Time-Series Grouping Unit and/or its Time-Series Analyzer Unit. For example, if a certain time-series repeatedly generates “false positive” erroneous alerts, the feedback can inform the system to modify its behavior analysis model for those specific time-series or reduce the weight that it gives to certain types of events. (7) Optionally, Fine-Tuning the Anomaly Detection Models, as feedback data can be used for adjusting the LSTM Model/Processor and the TFT Model/Processor (and/or other suitable ML/DL/AI modules or models or processing units that are utilized in a specific implementation). Optionally, the system can re-train these models using user-provided feedback as additional input, helping the models learn more accurate behavioral patterns and anomalies; and such dynamic learning ensures that the system becomes increasingly tailored to the organization's specific environment and reduces “false negative” errors or “false positive” errors over time. (8) Enhancing Mitigation Suggestions, as feedback on mitigation appropriateness can directly influence the system's Remediation/Mitigation Unit and its subsequent performance. By understanding how users view the proposed actions, the system can adjust future mitigation proposals. For example, if users consistently reject “account freeze” suggestions in favor of “file quarantine” suggestions, the system will begin recommending the latter step in similar future scenarios. Additionally, the system can factor in user feedback when proposing layered mitigation strategies that combine multiple actions based on the context. (9) Dynamic Severity Scoring/Risk Scoring, as the system's score generator unit becomes more accurate as it aggregates user feedback on previous alerts. Over time, it will better understand what constitutes a high, moderate, or low-risk scenario based on how users have responded to similar alerts/events in the past. (10) Refining Suppression Rules, or refining of alert discarding rules, as the Alert Suppression/Discarding Unit can learn from feedback on “false positive” erroneous alerts to refine the rules for suppressing benign alerts. For example, if users repeatedly mark certain types of alerts as low risk or non-critical, the system can learn to automatically suppress or discard such alerts in the future, reducing alert fatigue for security teams. (11) Optionally, Feedback Loop Data can be used as Additional Context for future iterations of anomaly detection; as the user feedback can be added or integrated into the Organizational Context Database, enriching the context that the system uses when evaluating future anomalies or future events. For instance, if a user repeatedly flags access to a specific repository as normal, despite the system detecting it as anomalous, this feedback can become part of the Organizational Context. In subsequent alerts, the system will consider this user-specific context when evaluating similar activities, thus avoiding unnecessary alerts. Conversely, if a user identifies an anomaly as high risk and confirms a breach, the system can automatically increase the severity of similar events in the future. As described above, the Feedback Loop mechanism can transform the system into an adaptive and continuously improving anomaly detection framework. By incorporating real-time user feedback into the decision-making process, the system refines its ability to detect relevant threats, reduce “false positive” errors, and propose appropriate remediation actions. This learning-driven feedback loop ensures that the system evolves alongside the organization, becoming more precise and tailored with every interaction.

In some embodiments, the LLM 221 can be used by the system for one or more roles or tasks, that may include (for example) the following. (1) Contextual Enrichment and Grounding, as a primary role of the LLM in some embodiments is to act as a context enrichment engine for the anomaly detection process. The system gathers vast amounts of Organizational Context (OC), such as user roles, devices, resource interactions, and behavioral patterns. This contextual information is important for accurate anomaly detection, but its sheer volume can overwhelm traditional ML/DL models. The LLM is utilized to process and synthesize this context into a meaningful, grounded form that is used to refine anomaly detection. For example, when the system analyzes a series of events related to a user accessing sensitive data, the LLM interprets not only the event itself but also its broader organizational context. It might consider the user's role, their typical behavior, and the organizational relevance of the data being accessed. By grounding the analysis in these real-world contextual cues, the LLM allows the system to perform more nuanced, precise anomaly detection, reducing false positives or negatives. (2) Processing Enriched Time-Series Data: the system applies Long Short-Term Memory (LSTM) and Temporal Fusion Transformer (TFT) models to analyze time-series data for detecting anomalies. However, these models are significantly enhanced by feeding them enriched data processed by the LLM. In this case, the LLM acts as an intermediary, transforming raw time-series data into an enriched format that includes relevant context. The LLM augments the time-series data with details about users, devices, or resources involved, allowing the anomaly detection models to make more informed decisions. For instance, instead of simply analyzing a series of file access events, the LLM interprets how these events relate to an individual's profile, organizational policies, and historical behavior patterns. By incorporating such enriched inputs, the LSTM and TFT models can more effectively differentiate between normal behavior and truly anomalous activity. (3) Reducing False Positive/False Negative Errors: conventional anomaly detection systems often suffer from a high rate of false positives (benign events are flagged as anomalies) and false negatives (actual security threats are overlooked by the system). The LLM can mitigate or reduce or prevent such errors by offering deeper contextual understanding. For example, an alert might be triggered when a user accesses a sensitive financial document; in a conventional system, this action could automatically raise a high-severity alert. However, the LLM, with its knowledge of the user's profile (e.g., they are a senior accountant in the Finance department), innovatively “understands” that such access is normal/acceptable/authorized behavior in this particular context, and may suppress or discard the alert, reducing false positive errors. Conversely, if a junior developer accesses the same financial document, the LLM's contextual awareness would flag this as highly anomalous, ensuring that no “false negative” error occurs. (4) Language-Based Pattern Recognition, as the system can harness the LLM's ability to recognize patterns within unstructured or semi-structured data, such as user communications, calendar entries, or meeting notes. By analyzing these forms of language data, the LLM can identify behavioral patterns or can extract insights that might not be obvious through standard log analysis. For example, if a user suddenly starts communicating frequently with an external partner who has no established relationship with their department, the LLM can flag this change as unusual. This provides an additional layer of security monitoring that is language-based rather than solely relying on numerical or categorical data. (5) Adaptive Learning from Feedback, as the LLM's role can extend to improving system performance over time through the Feedback Loop mechanism. Once users provide feedback on the accuracy of alerts or the appropriateness of remediation actions, this feedback is processed and stored for future use. The LLM uses this feedback to refine its understanding of what constitutes normal or anomalous behavior in the specific organizational context. By learning from feedback on false positives, false negatives, and mitigation strategies, the LLM continuously adapts and improves its ability to analyze future events more effectively. This adaptive learning ensures that the system becomes more personalized and efficient as it gathers more data over time.

For demonstrative purposes, some portions of the discussion above and/or herein relate to automated and LLM-assisted detection of anomalies or security risks or security deviations within an organization or by a team-member of an organization; however, some embodiments may similarly focus on, or may be configured to, detect anomalies/security risks/security deviations that pertain to a Partner Entity or a Business Partner (e.g., vendor, supplier, client, customer, contractor, consultant, service provider, product provider, distributor) or a Stakeholder (e.g., director in the organization, shareholder, executive, agent) or an Organization Team or Organization Unit or Organizational Department.

For example, the system may be configured to collect and automatically construct Organizational Context for a “Partner Entity”. The information sources for data collection may include, for example: email messages and instant messages and other digital messages that were sent from the organization to that Partner Entity, or that were received at the organization from that Partner Entity; records from CRM sub-system/ERP sub-system/Supply Chain Management (SCM) sub-system, such as outgoing invoices, incoming invoices, outgoing purchase orders, incoming purchase orders, data about contact persons at the Partner Entity; organizational documents that mention that Partner Entity (e.g., contracts, agreements, letters sent, letters received, legal documents, financial documents, marketing documents). The system may further obtain and process other data-items about the Partner Entity; such as, domain names and URLs that are associated with the Partner Entity, names of particular contact persons or team-members in the Partner Entity, information collected from website/s of the Partner Entity; data pertaining to bank account(s) of that Partner Entity, to which the organization pays or from which the organization receives payments; types or categories of information or documents that are typically disclosed to or shared with that Partner Entity (e.g., marketing materials, product brochures); and optionally also types or categories of information or documents that are typically not disclosed to or not shared with that Partner Entity (e.g., legal documents, financial records).

The LLM-assisted system may thus be configured and prompted to detect anomalies that are a deviation or an abnormality or are an irregularity relative to historic/past/recent patterns that the system identifies in the collected data, such as: (a) an anomaly message is generated if a document or a data-item is shared with the Partner Entity and that document/data-item is of a type or a category of documents or data-items that was not previously shared with that Partner Entity (e.g., financial records), or that document/data-item belongs to a sub-category or sub-type that appears to be a deviation from previous sharing patterns (e.g., previous communications had shared with the Partner Entity various product brochures that relate to Wireless Communication Devices, and a new communication shares with that Partner Entity a product brochure about Bicycles); (b) an anomaly message is generated if payment is performed, or is instructed or requested to be performed, towards a new bank account that is alleged to belong to that Partner Entity; (c) a possible anomaly message can be generated if the system detects that a communication is sent out from the organization to a new contact person/new recipient at the Partner Entity, or to a never-contacted-before person or email address at the Partner Entity; and so forth.

In another example, Organizational Context may be constructed with regard to an Organizational Team/Unit/Department/Group, and this may enable the system to detect anomalies or deviations from regular patterns in situations where a person in the organization that is outside of that Organizational Team/Unit/Department/Group has performed an irregular activity; for example, the system may automatically deduce a pattern indicating that only five particular members of the Marketing Department have sent marketing brochures to a particular Partner Entity (e.g., a distributor or a customer) in the past 6 months; and suddenly, detects the system automatically, a marketing brochure was sent out to that Partner Entity by a person who is a member of the R&D Department and is not a member of the Marketing Department, or by a person who is a member of the Marketing Department but is not one of the five people that typically/regularly send such marketing brochures to that Business Partner; and an anomaly alert may be generated. Alerts may be generated with regard to sending out of documents or information, with regard to internal access to particular documents/data-items/files/folders/drives/resources, and/or with regard to other types of animus events or events that the system automatically estimates to be of abnormal/irregular type.

Some embodiments of the present invention may generate one or more, or some, or most, or all, of the following innovative or non-obvious outputs. (1) Contextualized Anomaly Alerts, as the alert generation processed is enriched with detailed organizational context, including user roles, device types, and data access patterns; these alerts provide not only the detection of an anomaly but also insights into why the event is unusual within the specific context of the user or organization. (2) Risk-Adjusted Severity Scores, as alerts can be accompanied by dynamic severity scores that reflect both the nature of the anomaly and its organizational context; this helps security teams prioritize responses, focusing on high-risk anomalies while suppressing low-risk or benign activities. (3) Historical Behavior Reports, that can detail the historical behavior of users, devices, or resources, offering a comparison between normal activity and the detected anomaly; this output provides clarity on what constitutes regular behavior for each entity within the organization. (4) Multi-Entity Time-Series Correlation, as correlated time-series data that links events across multiple users, devices, or resources, can help identify coordinated activities or systemic security threats; this output makes it easier to detect patterns that span multiple entities, offering deeper insights into complex security risks. (5) Group-Level Anomaly Summaries, as the system can optionally be configured to summarizes anomalies at the group level (e.g., anomalies affecting all devices in the marketing department); this output provides an overview of coordinated or systemic issues within specific organizational departments or units, offering insights into department-wide security trends. (6) Anomaly Prediction Insights, as the system can optionally generate predictive insights that forecast potential future anomalies based on time-series data and past behavior; this output helps organizations proactively address security risks before they materialize, allowing for preventive measures to be taken. (7) Adaptive Feedback Reports, that can optionally highlight how user feedback on past alerts has been incorporated into the system's learning process; this shows the system's evolving understanding of what constitutes normal/authorized/benign behavior versus anomalous/risky/possible-threat behavior, improving user confidence in future alerting accuracy. (8) Automated Mitigation Actions Log, as the system creates a detailed log of mitigation actions taken by the system in response to anomalies, such as account freezes or file quarantines; and such output helps track the system's remediation efforts and provides transparency on how threats were handled without human intervention. (9) False Positive/False Negative Analysis, optionally generating reports analyzing past false positives and/or past false negatives, explaining why certain anomalies were misclassified and how the system has improved its accuracy; and this can allow security teams to assess the system's performance over time and evaluate its adaptability. (10) Behavioral Pattern Recognition Outputs, as detailed reports on detected behavioral patterns within the organization, such as how users interact with specific resources over time; these outputs can inform both security strategies and operational policies by identifying habits, workflows, or risky behavioral trends. (11) Organizational Context Maps, such as visual maps of organizational context, showing relationships between or among users, devices, and resources, and how they interact or change over time; this output can provide a useful view of organizational structure and resource access, helping security teams identify vulnerabilities in access controls. (12) Time-Series Behavior Deviation Reports, that specifically highlight deviations in time-series data, showing how recent behavior differs from established patterns; and this output can help organizations understand the underlying cause of anomalies by pinpointing where and when behavior shifted unexpectedly. (13) Customized Remediation Suggestions, providing dynamic remediation proposals that are tailored to the specific anomaly and its organizational context; and such outputs guide security teams on the most appropriate actions, considering the user's role, device importance, and the sensitivity of the affected resources, improving response precision.

Some embodiments of the present invention may solve or mitigate or prevent some, or most, or all, of the following problems or limitations or disadvantages of conventional systems. (1) High Rate of False Positives, as conventional anomaly detection systems often generate excessive “false positive” alerts, thereby overwhelming security teams; in contrast, by incorporating organizational context and user profiles, the system reduces unnecessary alerts by distinguishing between normal and anomalous behavior, helping focus resources on genuine threats. (2) Inability to take into account, or to recognize and understand, Organizational Context for the purpose of anomaly detection and risk assessment; as conventional systems lack the ability to interpret user roles, device types, and organizational structures; whereas embodiments of the present invention mitigate that issue by collecting, analyzing, generating and integrating Organizational Context into anomaly detection, ensuring that alerts are relevant and tailored to the specific environment. (3) Difficulty in Detecting Insider Threats, which are often overlooked by conventional systems due to the familiarity of threat actors with the environment; whereas embodiments of the present invention perform profiling of user behavior and comparing it to historical data with time-series analysis via ML/DL, and can thus detect subtle deviations from normal/authorized/expected behavior, effectively identifying potential insider threats. (4) Static Risk Scoring, as conventional systems apply rigid and static risk assessments/risk scores to anomalies, leading to misclassification of threats; whereas the system of the present invention can dynamically adjust risk scores based on the context of the anomaly and the relevant user/device/resource, enabling a more nuanced evaluation and reducing errors in threat prioritization. (5) Missed Multi-Entity Correlations, as conventional models often fail to analyze or correlate related events across different users, devices, or resources; whereas embodiments of the present invention can address that gap by grouping events into multi-entity time-series, uncovering coordinated attacks or systemic security issues that may be missed otherwise. (6) Slow Response to Emerging Threats, as conventional systems only react to detected anomalies after the fact; whereas some embodiments can optionally provide or utilize time-series forecasting and anomaly prediction capabilities, allowing organizations to anticipate future threats, and enabling a proactive response and preventing some security breaches even before they occur. (7) Overwhelming Volume of Alerts in large organizations, as the sheer volume of generated alerts can overwhelm security teams; whereas, by filtering alerts based on context and severity, the system of some embodiments of the present invention can reduce the burden on teams, ensuring they can focus on the most critical anomalies. (8) Manual Remediation Delays, as conventional systems often rely on human intervention for selecting and invoking remediation steps, thereby leading to mistakes and delays in threat response; whereas embodiments of the present invention automate or semi-automate the contextual selection and the deployment of mitigation actions, such as disabling accounts or quarantining files, providing faster and more effective responses to security threats. (9) Lack of Adaptive Learning, as conventional anomaly detection systems fail to learn from their own past mistakes, repeating the same or similar false positives or false negatives; whereas embodiments of the present invention may utilize a feedback loop mechanism that allows the system to continuously improve its accuracy, learning from user feedback to refine future anomaly detection. (10) Disparate Data Sources, as conventional systems struggle to analyze data that is spread across different platforms (e.g., CRM system, ERP system, email system, Active Directory); whereas embodiments of the present invention solve this by integrating multiple data sources into a unified system and generating unified Organizational Context, allowing for holistic analysis and more accurate detection of cross-system anomalies. (11) Undetected Insider Resource Misuse, especially by privileged users, that often goes unnoticed by conventional detection systems; whereas embodiments of the present invention utilize detailed user and resource profiling that helps the system to detect unauthorized access to sensitive data or resources, preventing insider misuse or data exfiltration before it escalates into a major breach. (12) Inconsistent Alert Relevance, as security alerts that are generated by conventional systems are often irrelevant or lack sufficient context, leading to security fatigue and to decision fatigue at the security team; whereas embodiments of the present invention can mitigate this issue by providing enriched alerts that include contextual information, improving the relevance and clarity of alerts to help security teams make better decisions. (13) Complexity in Analyzing Historical Behavior for anomaly detection, that conventional systems cannot handle; whereas embodiments of the present invention streamline that process by maintaining and updating detailed user, device, and resource profiles, allowing for efficient analysis and comparison of current activities to historical norms or patterns. (14) Inefficient Prioritization of Threats, as conventional systems fail to prioritize threats effectively, often treating all anomalies as equal; whereas embodiments of the present invention dynamically adjust alert severity based on organizational context, ensuring that critical threats are prioritized while low-risk activities are deprioritized or suppressed.

Some embodiments provide a method for Context-Aware Anomaly Detection, capable of detecting anomalies in an organizational network, comprising: collecting event data from users, devices, and resources within the network; constructing profiles for each entity based on historical behaviors; analyzing the event data using machine learning models enriched with organizational context; and generating alerts for detected anomalies based on deviations from established profiles.

Some embodiments provide a method for Time-Series Grouping of Events or event data in an organizational network, comprising: receiving a stream of events; identifying entities involved in each event; grouping the events into time-series based on entity types; and analyzing each time-series for patterns or deviations using machine learning models to detect anomalous activity.

Some embodiments provide a method for Dynamic Risk Scoring, or for dynamically scoring the risk of detected anomalies, comprising: gathering/collecting/generating organizational context, including user roles, device types, and data classifications; detecting an anomaly in event data; applying an ML/DL model to assign a risk score based on the anomaly's context; and adjusting the risk score dynamically based on feedback from previous alerts.

Some embodiments provide a method for Profile-Based Anomaly Detection, or for detecting anomalies based on entity profiles, comprising: generating profiles for users, devices, and resources by analyzing historical behavior patterns; comparing incoming event data against the profiles; identifying anomalies where the event deviates from typical behavior; and generating alerts based on the severity of the anomaly.

Some embodiments provide a method for Multi-Entity Time-Series Correlation, or for correlating anomalies across multiple entities, comprising: constructing time-series for each entity in an organizational network; analyzing the time-series data for individual entities; identifying correlations between time-series for different entities; and detecting coordinated anomalies that affect multiple users, devices, or resources.

Some embodiments provide a method for Feedback-Based Anomaly Detection Improvement, or for improving anomaly detection through user feedback, comprising: generating alerts for detected anomalies; receiving user feedback on the accuracy and severity of the alerts; storing the feedback in a feedback database; and incorporating the feedback into future anomaly detection processes by refining the machine learning models based on user-provided input.

Some embodiments provide a method for Automated Mitigation of Anomalies, or for automatically or semi-automatically mitigating anomalies in an organizational network, comprising: detecting an anomaly using a machine learning model enriched with organizational context; generating a mitigation recommendation based on the type and severity of the anomaly; and automatically executing mitigation actions, such as disabling user accounts or quarantining files, without requiring manual intervention.

Some embodiments provide a method for Enriching Event Data with Organizational Context, and particularly enriching event data for anomaly detection, by performing: collecting event data from users, devices, and resources; gathering organizational context, including user roles and data access patterns; combining the event data with organizational context; and using machine learning models to analyze the enriched data for anomaly detection.

Some embodiments provide a method for Partitioning Time-Series for Anomaly Detection, and particularly partitioning time-series data for improved anomaly detection, comprising: receiving time-series data for users, devices, and resources; partitioning the time-series into overlapping segments; analyzing each segment for behavioral deviations using machine learning models; and detecting anomalies in the partitioned data based on patterns across multiple segments.

Some embodiments can optionally provide a method for Predictive Anomaly Detection, or for predicting future anomalies in an organizational network, comprising: collecting and grouping event data into time-series; applying machine learning models, including Long Short-Term Memory (LSTM) and Temporal Fusion Transformer (TFT) models, to predict future behavior based on historical data; and generating alerts for potential future anomalies before they occur.

Some embodiments provide a method for Detecting Insider Threats in an organizational network, comprising: constructing user profiles based on access patterns and organizational roles; comparing real-time user behavior against the established profiles; detecting deviations indicative of insider threats; and generating alerts when abnormal access to sensitive data is detected.

Some embodiments provide a method for selective suppression of benign/harmless/non-risky system-generated alerts based on Organizational Context. For example, the method includes: detecting an anomaly using time-series analysis; evaluating the anomaly against the organizational context, including user roles and historical behavior; determining the likelihood of a false positive based on this context; and suppressing or discarded the alert if the behavior is deemed non-threatening/non-risky to the organization.

In some embodiments, the event data includes user logins, file access, file modifications, network activity, and/or application usage across the organizational network.

In some embodiments, the profiles are generated using (or based on, or by taking into account) historical data that spans at least one week/one month/N days/N weeks/N months of user, device, or resource activity; wherein N is a positive number.

In some embodiments, the machine learning models include one or more Long Short-Term Memory (LSTM) models to detect temporal patterns in the event data. In some embodiments, the machine learning models include one or more Temporal Fusion Transformer (TFT) models that incorporate time-series data for anomaly detection.

In some embodiments, the organizational context includes user roles/titles/tasks/positions, user belonging to departments or team, seniority/tenure, and/or access permissions within the organization. In some embodiments, the method includes dynamically updating the profiles based on newly acquired event data. In some embodiments, the profiles include information on device types, typical usage times, and geographic locations of the users and devices.

In some embodiments, the alert generation process includes assigning a severity score/risk score to each anomaly based on its deviation from the established profiles. In some embodiments, the severity score/risk score is determined or adjusted based on the sensitivity of the resource or data involved in the anomaly.

In some embodiments, the method includes filtering out or discarding or suppressing benign deviations in behavior that are deemed low-risk based on contextual analysis and/or based on prior user feedback that was provided with regard to prior anomalies or prior alerts.

In some embodiments, the ML/DL model is trained using supervised learning with labeled examples of past anomalous and non-anomalous behavior. In some embodiments, the ML/DL model optionally incorporates feedback from users to adjust the anomaly detection sensitivity for specific roles or departments.

In some embodiments, the alert message or alert notification may include recommendations or proposals for mitigating the anomaly, such as disabling user permission access or quarantining files. In some embodiments, the method includes providing real-time feedback to users regarding the validity/severity of the generated alerts. In some embodiments, the alert is transmitted to a system administrator or a manager, with a detailed explanation of the anomaly and its context. In some embodiments, the method includes storing the generated alerts in a centralized database for future analysis and review. In some embodiments, the alert severity score is adjusted based on the frequency of similar past anomalies for the same user or device. In some embodiments, the generated alert provides real-time recommendations for manual or automated remediation actions to be taken by the system administrator.

In some embodiments, the event data includes metadata, such as file creation times, modification times, and access permissions. In some embodiments, the system generates or deduces or creates user behavior patterns or heatmaps, illustrating or representing typical activity patterns of a user (or of multiple users) across time, relative to devices used and/or relative to resources used or accessed.

In some embodiments, profiles are constructed from a combination of user behavior, device interaction, and access patterns to sensitive resources. In some embodiments, the system is also configured to compare the anomaly against a database of known threat patterns to determine the risk level of the behavior. In some embodiments, the system automatically suppresses repeated “false positive” erroneous alerts based on previously submitted user feedback that related to previous system-detected anomalies or system-generated alerts (and not the currently-investigated event or anomaly).

In some embodiments, the method includes generating periodic reports on detected anomalies, summarizing the severity, frequency, and types of threats.

In some embodiments, optionally, the system may use multi-entity time-series analysis to detect coordinated anomalies across multiple users or devices.

In some embodiments, optionally, the system may use time-series data to predict potential future anomalies based on current trends in user behavior.

In some embodiments, the method includes automatically updating mitigation policies based on the type of detected anomaly and/or based on user feedback to system-detected anomalies or to system-generated alerts.

In some embodiments, the organizational context includes the classification of files or data based on sensitivity, importance, or confidentiality levels. In some embodiments, the method includes integrating external data sources, such as CRM or ERP systems, into the event data to detect anomalies across organizational systems.

Some embodiments provide a computerized method for detecting and handling security threats in an organizational network of an organization. The computerized method comprises: (a) collecting event data that pertain to organizational users, organizational devices, and organizational resources of the organizational network; (b) constructing user profiles, device profiles, and resource profiles; (c) constructing Organizational Context information that pertains to organizational users, organizational devices, and organizational resources; (d) constructing a time-series of events, enriched with said Organizational Context information; (e) analyzing said time-series of events using a Machine Learning process that detects an anomalous event, and automatically generating an alert message pertaining to and describing said anomalous event.

In some embodiments, step (e) comprises: applying to said time-series of events a Long Short-Term Memory (LSTM) analysis that, is configured (i) to detect patterns over time and to identify deviations from expected behavior, and (ii) to detect said anomalous event by analyzing event sequences and their respective Organizational Context information and that detects pattern.

In some embodiments, step (e) comprises: applying to said time-series of events a Temporal Fusion Transformers (TFT) analysis, that is configured (i) to detect patterns over time and to identify deviations from expected behavior, and (ii) to detect said anomalous event by analyzing event sequences and their respective Organizational Context information and that detects pattern.

In some embodiments, step (e) comprises: (e1) detecting an anomalous data-point in said time-series of events; (e2) based on Organizational Context information, determining that said anomalous data-point more probably does not correspond to a security threat; and therefore, discarding an alert that pertains to said anomalous data-point.

In some embodiments, step (e) comprises: (e1) detecting an anomalous data-point in said time-series of events; (e2) based on Organizational Context information, determining that said anomalous data-point more probably corresponds to a security threat; and therefore, generating and sending an alert message that pertains to said anomalous data-point.

In some embodiments, step (d) comprises: enriching the time-series of events by commanding a Large Language Model (LLM) to enrich the time-series of events based on data extracted from organizational sources.

In some embodiments, step (d) comprises: obtaining data describing a set of events; identifying entities involved in each event; grouping the events into time-series based on entity types; analyzing each time-series for patterns or deviations using a Machine Learning models that is configured to detect anomalous activity.

In some embodiments, the method comprises: dynamically scoring a risk of detected anomalies, by performing: generating Organizational Context information that includes user roles, device types, and data classifications; detecting an anomaly in event data in said time-series of events; applying a Machine Learning model to assign a risk score based on Organizational Context information that relates to said anomaly.

In some embodiments, the method comprises: performing a profile-based anomaly detection of anomalies based on entity profiles, by: generating profiles for users, devices, and resources by analyzing historical behavior patterns; comparing incoming event data against the generated profiles; identifying anomalies where the event deviates from typical behavior; generating one or more alerts based on estimated severity of the anomaly.

In some embodiments, the method comprises: performing multi-entity time-series correlation by correlating anomalies across multiple entities, by performing: constructing time-series for each entity in an organizational network; analyzing the time-series data for individual entities; identifying correlations between time-series for different entities; detecting coordinated anomalies that affect multiple users, devices, or resources.

In some embodiments, the method comprises: (f1) generating alerts for detected anomalies; (f2) receiving user feedback about accuracy of the alerts and severity of the alerts; (f3) storing the user feedback in a feedback database; (f4) incorporating the user feedback into a subsequent anomaly detection process by refining the Machine Learning model based on said user feedback about prior alerts.

In some embodiments, the method comprises: in response to said alert message, automatically invoking one or more pre-defined mitigation processes or remediation processes, that are selected from a pool of processes by taking into account at least (i) one or more characteristics of the generated alert, and (ii) an estimated severity level of the generated alert.

In some embodiments, the method comprises: partitioning the time-series of events into overlapping segments; analyzing each segment for behavioral deviations using the Machine Learning model; detecting an anomaly in the partitioned data based on patterns across multiple segments.

In some embodiments, the method comprises: predicting future anomalies in the organizational network, by performing: collecting and grouping event data into time-series; applying the Machine Learning model to said time-series to predict future behavior based on historical data; generating alerts for potential future anomalies before they occur.

In some embodiments, the method comprises: detecting insider threats in said organizational network, by performing: constructing user profiles based on access patterns and organizational roles; comparing real-time user behavior against established user profiles; detecting deviations that are indicative of insider threats; generating alerts upon detection of abnormal access to sensitive data.

In some embodiments, the method comprises: selectively suppressing benign or non-risky system-generated alerts based on Organizational Context, by performing: detecting an anomaly using time-series analysis; evaluating the anomaly against the Organizational Context information, including at least user roles and historical behavior; determining a likelihood of a false positive error based on said Organizational Context information; suppressing or discarded the alert if the behavior is deemed non-threatening or non-risky to the organization in view of said Organizational Context information.

In some embodiments, step (a) of collecting event data further comprises: collecting event data that pertains at least to (a1) communications between the organization and a third-party entity, (a2) payments between the organization and the third-party entity; wherein the time-series of events is analyzed by a process that is configured to detect abnormal communications or abnormal payments from the organization towards the third-party entity.

Some embodiments provide a system comprising: one or more hardware processors, that are configured to execute code, and that are operably associated with one or more memory units; wherein the one or more hardware processors are configured to perform a method as described.

Some embodiments provide a non-transitory storage medium having stored thereon instructions that, when executed by a machine, cause the machine to perform a method as described.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be implemented by using hardware units, software units, processors, CPUs, DSPs, GPUs, integrated circuits (ICs), memory units, storage units, wireless communication modems or transmitters or receivers or transceivers, cellular transceivers, a power source, input units, output units, Operating System (OS), drivers, applications, and/or other suitable components.

Some embodiments may be implemented by using a special-purpose machine or a specific-purpose that is not a generic computer, or by using a non-generic computer or a non-general computer or machine. Such system or device may utilize or may comprise one or more units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented by using code or program code or machine-readable instructions or machine-readable code, which is stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such device to perform a method in accordance with the present invention.

Some embodiments may be utilized with a variety of devices or systems having a touch-screen or a touch-sensitive surface; for example, a smartphone, a cellular phone, a mobile phone, a smart-watch, a tablet, a handheld device, a portable electronic device, a portable gaming device, a portable audio/video player, an Augmented Reality (AR) or Virtual Reality (VR) or Mixed Reality (XR) device or headset or gear, a “kiosk” type device, a vending machine, an Automatic Teller Machine (ATM), a laptop computer, a desktop computer, a vehicular computer, a vehicular dashboard, a vehicular touch-screen, or the like.

The system(s) and/or device(s) of some embodiments may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of some embodiments may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with some embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit, a Flash drive), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, MATLAB, Pascal, HTML, HTML5, CSS, Dart, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results (e.g., within a pre-defined threshold level of similarity; such as, within 5 percent above or below a pre-defined threshold value), among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some embodiments have been illustrated and described herein, many modifications, substitutions, changes, and equivalents may occur to those skilled in the art. Accordingly, the claims are intended to cover all such modifications, substitutions, changes, and equivalents.

What is claimed is:

1. A computerized method for detecting and handling security threats in an organizational network of an organization,
the computerized method comprising:
(a) collecting event data that pertain to organizational users, organizational devices, and organizational resources of the organizational network;
(b) constructing user profiles, device profiles, and resource profiles;
(c) constructing Organizational Context information that pertains to organizational users, organizational devices, and organizational resources;
(d) constructing a time-series of events, enriched with said Organizational Context information;
(e) analyzing said time-series of events using a Machine Learning process that detects an anomalous event, and automatically generating an alert message pertaining to and describing said anomalous event.

2. The computerized method of claim 1,
wherein step (e) comprises:
applying to said time-series of events a Long Short-Term Memory (LSTM) analysis that, is configured (i) to detect patterns over time and to identify deviations from expected behavior, and (ii) to detect said anomalous event by analyzing event sequences and their respective Organizational Context information and that detects pattern.

3. The computerized method of claim 1,
wherein step (e) comprises:
applying to said time-series of events a Temporal Fusion Transformers (TFT) analysis, that is configured (i) to detect patterns over time and to identify deviations from expected behavior, and (ii) to detect said anomalous event by analyzing event sequences and their respective Organizational Context information and that detects pattern.

4. The computerized method of claim 1,
wherein step (e) comprises:
(e1) detecting an anomalous data-point in said time-series of events;
(e2) based on Organizational Context information, determining that said anomalous data-point more probably does not correspond to a security threat; and therefore, discarding an alert that pertains to said anomalous data-point.

5. The computerized method of claim 1,
wherein step (e) comprises:
(e1) detecting an anomalous data-point in said time-series of events;
(e2) based on Organizational Context information, determining that said anomalous data-point more probably corresponds to a security threat; and therefore, generating and sending an alert message that pertains to said anomalous data-point.

6. The computerized method of claim 1,
wherein step (d) comprises:
enriching the time-series of events by commanding a Large Language Model (LLM) to enrich the time-series of events based on data extracted from organizational sources.

7. The computerized method of claim 1,
wherein step (d) comprises:
obtaining data describing a set of events;
identifying entities involved in each event;
grouping the events into time-series based on entity types;
analyzing each time-series for patterns or deviations using a Machine Learning models that is configured to detect anomalous activity.

8. The computerized method of claim 1, comprising:
dynamically scoring a risk of detected anomalies, by performing:
generating Organizational Context information that includes user roles, device types, and data classifications;
detecting an anomaly in event data in said time-series of events;
applying a Machine Learning model to assign a risk score based on Organizational Context information that relates to said anomaly.

9. The computerized method of claim 1, comprising:
performing a profile-based anomaly detection of anomalies based on entity profiles, by:
generating profiles for users, devices, and resources by analyzing historical behavior patterns;
comparing incoming event data against the generated profiles;
identifying anomalies where the event deviates from typical behavior;
generating one or more alerts based on estimated severity of the anomaly.

10. The computerized method of claim 1,
performing multi-entity time-series correlation by correlating anomalies across multiple entities, by performing:
constructing time-series for each entity in an organizational network;
analyzing the time-series data for individual entities;
identifying correlations between time-series for different entities;
detecting coordinated anomalies that affect multiple users, devices, or resources.

11. The computerized method of claim 1,
further comprising:
(f1) generating alerts for detected anomalies;
(f2) receiving user feedback about accuracy of the alerts and severity of the alerts;
(f3) storing the user feedback in a feedback database;
(f4) incorporating the user feedback into a subsequent anomaly detection process by refining the Machine Learning model based on said user feedback about prior alerts.

12. The computerized method of claim 1,
further comprising:
in response to said alert message, automatically invoking one or more pre-defined mitigation processes or remediation processes, that are selected from a pool of processes by taking into account at least (i) one or more characteristics of the generated alert, and (ii) an estimated severity level of the generated alert.

13. The computerized method of claim 1, further comprising:
partitioning the time-series of events into overlapping segments;
analyzing each segment for behavioral deviations using the Machine Learning model;
detecting an anomaly in the partitioned data based on patterns across multiple segments.

14. The computerized method of claim 1, further comprising:
predicting future anomalies in the organizational network, by performing:
collecting and grouping event data into time-series;
applying the Machine Learning model to said time-series to predict future behavior based on historical data;
generating alerts for potential future anomalies before they occur.

15. The computerized method of claim 1, comprising:
detecting insider threats in said organizational network, by performing:
constructing user profiles based on access patterns and organizational roles;
comparing real-time user behavior against established user profiles;
detecting deviations that are indicative of insider threats;
generating alerts upon detection of abnormal access to sensitive data.

16. The computerized method of claim 1, comprising:
selectively suppressing benign or non-risky system-generated alerts based on Organizational Context, by performing:
detecting an anomaly using time-series analysis;
evaluating the anomaly against the Organizational Context information, including at least user roles and historical behavior;
determining a likelihood of a false positive error based on said Organizational Context information;
suppressing or discarded the alert if the behavior is deemed non-threatening or non-risky to the organization in view of said Organizational Context information.

17. The computerized method of claim 1,
wherein step (a) of collecting event data further comprises:
collecting event data that pertains at least to (a1) communications between the organization and a third-party entity, (a2) payments between the organization and the third-party entity;
wherein the time-series of events is analyzed by a process that is configured to detect abnormal communications or abnormal payments from the organization towards the third-party entity.

18. The computerized method of claim 1,
wherein said process is configured to automatically detect at least one of:
(I) an event of sending an information item from the organization to said third-party entity, wherein the information item does not belong to a type of information items that are typically sent from the organization to said third-party entity;
(II) an event of sending an information item from the organization to said third-party entity, wherein the information item is sent by a sender within the organization that does not typically send any communications to said third-party entity;
(III) an event of sending an information item from the organization to said third-party entity, wherein the information item is sent by a sender within the organization that does not typically send said type of information items to said third-party entity;
(IV) an event of payment to a new bank account of said third-party entity.

19. A system comprising:
one or more hardware processors, that are configured to execute code,
and that are operably associated with one or more memory units;
wherein the one or more hardware processors are configured to perform a computerized process for detecting and handling security threats in an organizational network of an organization,
the computerized process comprising:
(a) collecting event data that pertain to organizational users, organizational devices, and organizational resources of the organizational network;
(b) constructing user profiles, device profiles, and resource profiles;
(c) constructing Organizational Context information that pertains to organizational users, organizational devices, and organizational resources;
(d) constructing a time-series of events, enriched with said Organizational Context information;
(e) analyzing said time-series of events using a Machine Learning process that detects an anomalous event, and automatically generating an alert message pertaining to and describing said anomalous event.

20. A non-transitory storage medium having stored thereon instructions that, when executed by a machine, cause the machine to perform a computerized process for detecting and handling security threats in an organizational network of an organization,
the computerized process comprising:
(a) collecting event data that pertain to organizational users, organizational devices, and organizational resources of the organizational network;
(b) constructing user profiles, device profiles, and resource profiles;
(c) constructing Organizational Context information that pertains to organizational users, organizational devices, and organizational resources;
(d) constructing a time-series of events, enriched with said Organizational Context information;
(e) analyzing said time-series of events using a Machine Learning process that detects an anomalous event, and automatically generating an alert message pertaining to and describing said anomalous event.
